(19) United States
(12) Patent Application Publication
(10) Pub. No.: US 2013/0118530 A1
(43) Pub. Date: May 16, 2013

(54) CLEANING APPARATUS, SEPARATION SYSTEM AND CLEANING METHOD

(71) Applicant: TOKYO ELECTRON LIMITED, Tokyo (JP)

(72) Inventors: Hiroshi KOMEDA, Kumamoto (JP); Eiji MANABE, Kumamoto (JP); Shinji KOGA, Kumamoto (JP); Takahide SAKAI, Kumamoto (JP)

(73) Assignee: TOKYO ELECTRON LIMITED, Tokyo (JP)

(21) Appl. No.: 13/669,722

(22) Filed: Nov. 6, 2012

(30) Foreign Application Priority Data
Nov. 16, 2011 (JP) 2011-250379

(51) Int. Cl. B08B 7/04; B08B 3/02; B08B 5/04

(52) U.S. Cl. 134/21; 134/59

(57) ABSTRACT

The present disclosure provides a cleaning apparatus that includes a wafer holding unit configured to hold and rotate a target wafer W, and a cleaning jig with a supplying surface that covers a joint surface of the target wafer W. The cleaning jig is provided with a gas-liquid supplying unit configured to supply a solvent of an adhesive, a rinse liquid of the solvent and an inert gas into a gap between the joint surface and the supplying surface. The cleaning jig is also provided with a suction unit configured to suck the solvent or rinse liquid (mixed liquid) which is supplied to the gap between the joint surface and the supplying surface, and a gas supplying unit configured to supply gas to a step portion.

### CROSS-REFERENCE TO RELATED APPLICATIONS

This application is based on and claims priority from Japanese Patent Application No. 2011-250379, filed on Nov. 16, 2011, with the Japanese Patent Office, the disclosure of which is incorporated herein in its entirety by reference.

### TECHNICAL FIELD

The present disclosure relates to a cleaning apparatus that cleans a joint surface of a target substrate separated from a complex substrate and disposed in an inner side of an annular frame to be held by a tape adhered on the surface of the annular frame and a non-joint surface of the target substrate, a separation system with the cleaning apparatus, a cleaning method using the cleaning apparatus, a program and a computer-readable storage medium.

### BACKGROUND

The diameter of a semiconductor wafer (“a wafer”) is becoming increased recently in a manufacturing process of, for example, a semiconductor device. In addition, a thin film wafer is required in a specific process such as, for example, a mounting. For example, when a thin wafer which has a large-diameter is transported or polished as it is, there is a concern that a warpage or a crack may occur. As a result, for example, to reinforce a wafer, the wafer may be bonded to a glass substrate or a wafer as a support substrate. Then, after a predetermined processing such as, for example, a polishing of the wafer in a state where the wafer and the support substrate are bonded, the wafer is separated (e.g., detached) from the support substrate.

Such a separation of the wafer and the support substrate is performed using, for example, a separating apparatus. The separating apparatus includes, for example, a first holder that holds a wafer, a second holder that holds a support substrate, and a nozzle that injects a liquid between the wafer and the support substrate. In the separating apparatus, the liquid is injected from the nozzle to a bonded space between the wafer and the support substrate with an injection pressure larger than the bonding strength between the wafer and the support substrate, for example, with an injection pressure larger than two times of the bonding strength, thereby performing the separation of the wafer and the support substrate (see, e.g., Japanese Patent Application Laid-Open No. 9-167724). Each of the joint surfaces of the wafer and the support substrate is then cleaned, and the separation processing of the wafer and the support substrate is completed.

### SUMMARY

The present disclosure provides a cleaning apparatus comprising: a rotation holding unit configured to hold and rotate a target substrate in a state in which, after the target substrate is separated from a complex substrate where the target substrate and a support substrate are bonded using an adhesive, the separated target substrate is disposed in an inner side of an annular frame and held by a tape adhered on the surface of the annular frame and a non-joint surface of the target substrate; and a cleaning jig including a supplying surface configured to cover a joint surface of the target substrate, the cleaning jig further including: a cleaning liquid supplying unit configured to supply a cleaning liquid between the joint surface and the supplying surface, thereby cleaning the joint surface of the target substrate, and a cleaning liquid suction unit configured to suck the cleaning liquid supplied between the joint surface and the supplying surface.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a plan view illustrating a schematic configuration of a separation system according to the present exemplary embodiment.

FIG. 2 is a longitudinally cross-sectional view illustrating a complex wafer held by a dicing frame and a dicing tape.

FIG. 3 is a plan view illustrating the complex wafer held by a dicing frame and a dicing tape.

FIG. 4 is a longitudinally cross-sectional view illustrating a schematic configuration of a separating apparatus.

FIG. 5 is a vertically cross-sectional view illustrating schematic configurations of a first holding unit, a second holding unit and a third holding unit.

FIG. 6 is a plan view illustrating the schematic configuration of the second holding unit.

FIG. 7 is a plan view illustrating a schematic configuration of a first vertical moving unit.

FIG. 8 is a longitudinally cross-sectional view illustrating a schematic configuration of a cleaning apparatus.

FIG. 9 is a longitudinally cross-sectional view illustrating a schematic configuration of a cleaning jig.

FIG. 10 is a transversely cross-sectional view illustrating the schematic configuration of the cleaning apparatus.

FIG. 11 is a plan view illustrating the schematic configuration of the cleaning jig.

FIG. 12 is a lateral view illustrating the schematic configuration of the cleaning jig.

FIG. 13 is a transversely cross-sectional view illustrating the schematic configuration of the cleaning apparatus.

FIG. 14 is a lateral view illustrating a schematic configuration of a transfer arm.

FIG. 15 is a lateral view illustrating a schematic configuration of a transporting device.

FIG. 16 is a plan view illustrating a schematic configuration of a first transporting arm.

FIG. 17 is a plan view illustrating a schematic configuration of a second transporting arm.

FIG. 18 is an explanatory view illustrating a state where a complex wafer is held by the first holding unit, the second holding unit and the third holding unit.

FIG. 19 is an explanatory view illustrating a state where the peripheral of the third holding unit is moved vertically and downwardly by the first vertical moving unit.

FIG. 20 is an explanatory view illustrating a state where the third holding unit is moved vertically and downwardly by a second vertical moving unit.

FIG. 21 is an explanatory view illustrating a state where the target wafer and the support wafer are separated.

FIGS. 22A to 22F are explanatory views illustrating a state where the target wafer is cleaned in the cleaning apparatus, in which FIG. 22A illustrates a state where the cleaning jig is disposed in a predetermined position, FIG. 22B illustrates a state where a solvent is supplied from a gas-liquid supplying unit to a gap between the supplying surface and the joint surface, FIG. 22C illustrates a state where the solvent is diffused in the gap, FIG. 22D illustrates a state where a rinse liquid is supplied from the gas-liquid supplying unit to the gap, FIG. 22E illustrates a state where a mixed liquid is diffused in the gap, and FIG. 22F illustrates a state where an inert gas is supplied from the gas-liquid supplying unit to the gap.

FIG. 23 is a plan view illustrating a schematic configuration of a cleaning jig according to another exemplary embodiment.

FIG. 24 is a longitudinally cross-sectional view illustrating a schematic configuration of the cleaning jig according to another exemplary embodiment.

FIG. 25 is a longitudinally cross-sectional view illustrating a schematic configuration of a cleaning jig according to even another exemplary embodiment.

FIG. 26 is a longitudinally cross-sectional view illustrating a schematic configuration of a cleaning jig according to still another exemplary embodiment.

FIG. 27 is a longitudinally cross-sectional view illustrating a schematic configuration of a cleaning jig according to still another exemplary embodiment.

FIG. 28 is a plan view illustrating a schematic configuration of a separation system according to another exemplary embodiment.

FIG. 29 is a lateral view illustrating a schematic configuration of a second transporting device.

FIG. 30 is a plan view illustrating a schematic configuration of a transporting arm.

FIG. 31 is a longitudinally cross-sectional view illustrating a schematic configuration of a second cleaning apparatus.

FIG. 32 is a transversely cross-sectional view illustrating a schematic configuration of the second cleaning apparatus.

FIG. 33 is an explanatory view illustrating a state where a target wafer is transferred from a first holding unit and a second holding unit to a transporting arm.

FIG. 34 is an explanatory view illustrating a state where the target wafer is transferred from the transporting arm to a wafer holding unit.

### DETAILED DESCRIPTION

In the following detailed description, reference is made to the accompanying drawing, which form a part hereof. The illustrative embodiments described in the detailed description, drawing, and claims are not meant to be limiting. Other embodiments may be utilized, and other changes may be made, without departing from the spirit or scope of the subject matter presented here.

As a wafer is configured to be thin, the wafer may be disposed in an inner side of an annular dicing frame and held by a dicing tape adhered on the surface of the dicing frame and a non-joint surface of the wafer. That is, after a wafer and a support substrate is separated, the wafer of which a joint surface needs to be cleaned may be held by the dicing frame and the dicing tape.

In the cleaning of the joint surface of the wafer as described above, for example, a solvent for an adhesive that bonds the wafer with the support substrate, is used. During the cleaning of the wafer, the solvent supplied on the joint surface of the wafer is introduced onto the dicing tape between the wafer and the dicing frame. As a result, the dicing tape may be damaged by the solvent. In this case, the dicing tape may not hold the wafer properly, and thus, a subsequent transport or a post-processing may be disrupted.

The present disclosure has been made in an effort to clean a joint surface of a target substrate properly in a state where the target substrate is disposed in an inner side of an annular frame and held by the annular frame and a tape.

An aspect of the present disclosure provides a cleaning apparatus comprising: a rotation holding unit configured to hold and rotate a target substrate in a state in which, after the target substrate is separated from a complex substrate where the target substrate and a support substrate are bonded using an adhesive, the separated target substrate is disposed in an inner side of an annular frame and held by a tape adhered on the surface of the annular frame and a non-joint surface of the target substrate; and a cleaning jig including a supplying surface configured to cover a joint surface of the target substrate, the cleaning jig further including: a cleaning liquid supplying unit configured to supply a cleaning liquid between the joint surface and the supplying surface, thereby cleaning the joint surface of the target substrate, and a cleaning liquid suction unit configured to suck the cleaning liquid supplied between the joint surface and the supplying surface. Meanwhile, the joint surface of the target substrate represents a surface, which is bonded to the support substrate, in the target substrate of a complex substrate, and the non-joint surface of the target substrate represents a surface which is not bonded to the support substrate, in the target substrate of the complex substrate. Further, the cleaning liquid includes a solvent of a rinse liquid in addition to a solvent of an adhesive.

Another aspect of the present disclosure provides a separation system comprising: a processing station including a separating apparatus configured to separate a complex substrate into a target substrate and a support substrate, a cleaning apparatus configured to clean the target substrate separated by the separating apparatus, and a cleaning apparatus configured to clean the support substrate separated by the separating apparatus; a carrying-in/out station configured to carry in/out the target substrate, the support substrate or the complex substrate with respect to the processing station; and a transporting device configured to transport the target substrate, the support substrate or the complex substrate between the processing station and the carrying-in/out station. The separation system includes the cleaning apparatus including: a rotation holding unit configured to hold and rotate a target substrate in a state in which, after the target substrate is separated from a complex substrate where the target substrate and a support substrate are bonded using an adhesive, the separated target substrate is disposed in an inner side of an annular frame and held by a tape adhered on the surface of the annular frame and a non-joint surface of the target substrate; and a cleaning jig including a supplying surface configured to cover a joint surface of the target substrate, the cleaning jig further including: a cleaning liquid supplying unit configured to supply a cleaning liquid between the joint surface and the supplying surface, thereby cleaning the joint surface of the target substrate, and a cleaning liquid suction unit configured to suck the cleaning liquid supplied between the joint surface and the supplying surface.

Even another aspect of the present disclosure provides a cleaning method comprising: disposing a cleaning jig to face a target substrate such that a supplying surface of a cleaning jig, which is configured to supply a solvent of adhesive on a joint surface of the target substrate, covers the joint surface in a state in which, after the target substrate is separated from a complex substrate where the target substrate and a support substrate are bonded using the adhesive, the separated target substrate is disposed in an inner side of an annular frame and held by a tape adhered on the surface of the annular frame and a non-joint surface of the target substrate; supplying a cleaning liquid between the supplying surface of the cleaning jig and the joint surface of the target substrate to diffuse the supplied cleaning liquid on the joint surface while rotating the target substrate, thereby cleaning the joint surface of the target substrate; and sucking the cleaning liquid diffused on the joint surface of the target substrate.

According to the present disclosure, the joint surface of the target substrate may be cleaned properly in a state where the target substrate is disposed in the inner side of the annular frame and held by the frame and the tape.

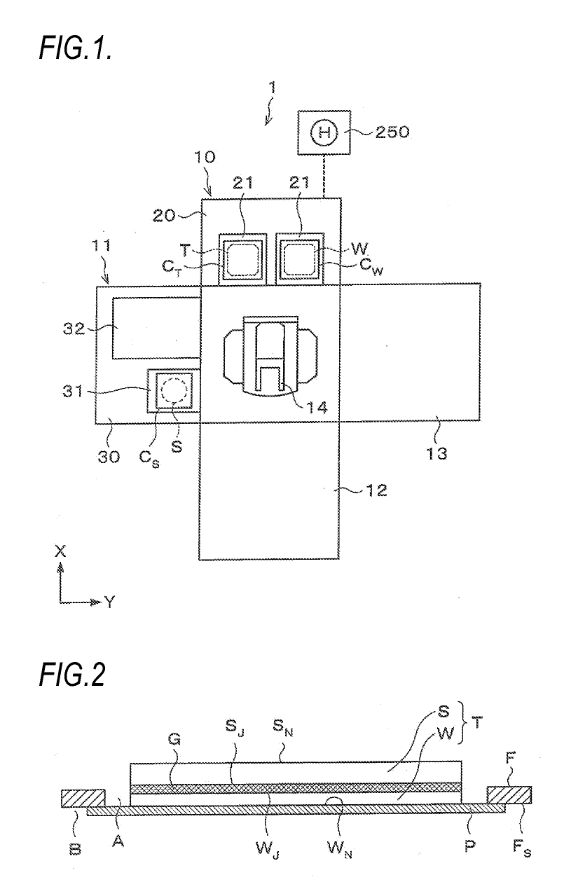

Hereinafter, the exemplary embodiments of the present disclosure will be described. FIG. 1 is a plan view illustrating a schematic configuration of a separation system 1 according to the present exemplary embodiment.

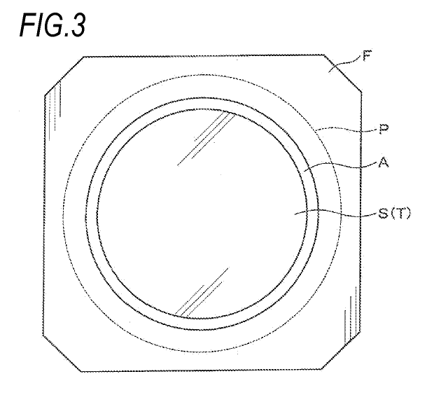

In a separation system 1, a complex wafer T (e.g., a complex substrate) where a target wafer W (e.g., a target substrate) and a support wafer S (e.g., a support substrate) are bonded using an adhesive G, is separated into target wafer W and support wafer S, as illustrated in FIGS. 2 and 3. Hereinafter, a surface of target wafer W which is bonded to support wafer S through adhesive G is represented as a joint surface W_{J}, and a surface which is opposite to joint surface W_{J} is represented as a non-joint surface W_{N}. Similarly, a surface of support wafer S which is bonded to target wafer W through adhesive G is represented as a joint surface S_{J}, and a surface which is opposite to joint surface S_{J} is represented as a non-joint surface S_{N}. Target wafer W is a wafer to be made as a product, and for example, a plurality of electronic circuits are formed on joint surface W_{J}. In target wafer W, for example, non-joint surface W_{N} is polished to be thinner (for example, 50 μm in thickness). Support wafer S has the same diameter as the diameter of target wafer W, and is a wafer that supports target wafer W. In the present exemplary embodiment, even though a case in which a wafer is used as a support substrate is described, other substrate such as, for example, a glass substrate may be used as the support substrate.

A dicing frame F and a dicing tape P are attached on complex wafer T. Dicing frame F has a substantially rectangular shape when viewed from above, and has an annular shape where an opening is formed along the peripheral of complex wafer T in an inner side of the frame. Complex wafer T is disposed in the opening at the inner side of dicing frame F. Dicing frame F is made of, for example, a stainless steel. Dicing tape P has a substantially circle shape when viewed from above, and is bonded to a surface F_{S} of dicing frame F and non-joint surface W_{N} of target wafer W. In this way, complex wafer T is held by dicing frame F and dicing tape P. Further, a gap is formed between complex wafer T and dicing frame F, and a step portion A is formed above dicing tape P in the gap. Dicing tape P is not bonded up to an end portion of surface F_{S} of dicing frame F in view of manufacturing circumstances, a step B exists between dicing tape P in the peripheral of dicing frame F by the thickness of dicing tape P. Meanwhile, dicing frame F in the present exemplary embodiment has a substantially rectangular shape when viewed from above, but dicing frame F may be formed in various shapes, for example, a circle shape. Further, dicing tape P has a substantially circle shape when viewed from above, but dicing tape P may be formed in various shapes, for example, in a substantially rectangular shape.

In separation system 1, complex wafer T is separated into target wafer W and support wafer S while complex wafer T is held by dicing frame F and dicing tape P. The separated target wafer W is transported in a state where target wafer W is held by dicing frame F and dicing tape P, and a post-processing, for example, a cleaning of joint surface W_{J} is performed.

As illustrated in FIG. 1, separation system 1 includes: a first carrying-in/out station 10 in which cassettes C_{W}, C_{T} capable of receiving a plurality of target wafers W and a plurality of complex wafers T, respectively, are carried-in/out with respect to the outside; a second carrying-in/out station 11 in which a cassette C_{S} capable of receiving a plurality of support wafers S is carried-in/out with respect to the outside; a separating apparatus 12 that separates complex wafer T into target wafer W and support wafer S; a cleaning apparatus 13 that cleans the separated target wafer W; a transporting device 14 that transports target wafer W, support wafer S, complex wafer T within separation system 1. First carrying-in/out station 10, second carrying-in/out station 11, separating apparatus 12 and cleaning apparatus 13 are disposed such that they are arranged in this order in an anti clock-wise rotational direction around transporting device 14 when viewed from above.

First carrying-in/out station 10 is provided with a cassette disposing table 20 which is provided with, for example, two cassette disposing plates 21. Cassette disposing plates 21 are disposed side by side in a Y-direction (left and right direction in FIG. 1). Cassettes C_{W}, C_{T} may be disposed in cassette disposing plates 21 when cassettes C_{W}, C_{T} are carried-in/out with respect to the outside of separation system 1. In this way, first carrying-in/out station 10 is constructed to retain the plurality of target wafers W and the plurality of complex wafers T. Target wafer W and complex wafer T are held by dicing frame F and dicing tape P, respectively. In first carrying-in/out station 10, the number of cassette disposing plate 21 is not limited to the present exemplary embodiment, but may be determined arbitrarily.

Second carrying-in/out station 11 is provided with a cassette disposing table 30. Cassette disposing table 30 is provided with, for example, one cassette disposing plate 31. Cassette C_{S} may be disposed in cassette disposing plate 31 when cassette C_{S} is carried-in/out with respect to the outside of separation system 1. In this way, second carrying-in/out station 11 is constructed to retain the plurality of support wafers S. At a plus side in an X-direction (up direction in FIG. 1) adjacent to cassette disposing plate 31, a reversing device 32 that reverses the front/rear surfaces of target wafer W is disposed.

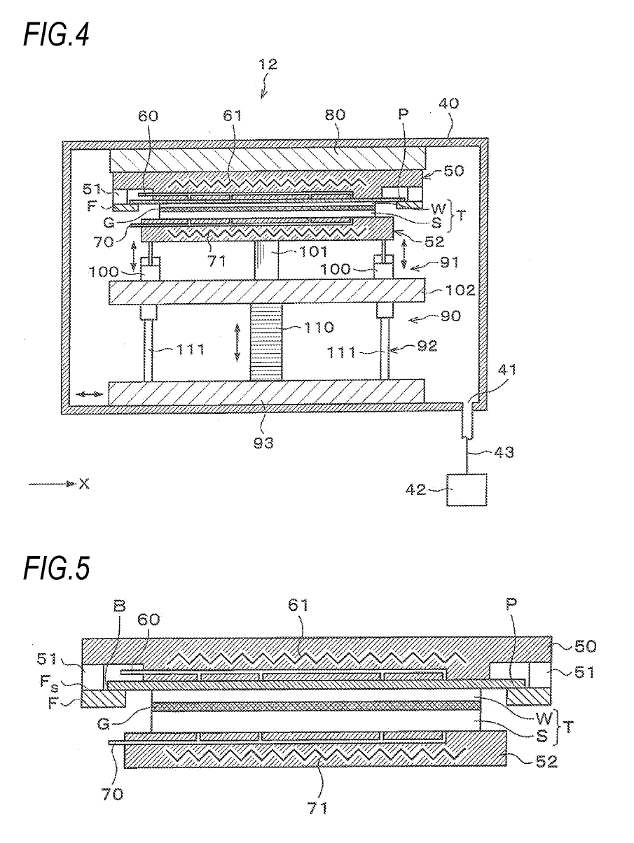

Next, the configuration of separating apparatus 12 will be described. Separating apparatus 12 includes a processing chamber 40 as illustrated in FIG. 4. A carrying-in/out port (not illustrated) for target wafer W, support wafer S and complex wafer T is formed in a lateral side of processing chamber 40, and the carrying-in/out port is provided with an opening/closing shutter (not illustrated). Processing chamber 40 is configured such that an atmosphere from an area where transporting device 14 is installed is introduced into processing chamber 40. Target wafer W and complex wafer T are held by dicing frame F and dicing tape P, respectively.

A suction port 41 that sucks the atmosphere within processing chamber 40 is formed on a bottom surface of processing chamber 40. A suction pipe 43 communicated with a negative pressure generating device 42 such as, for example, a vacuum pump is connected to suction port 41.

A first holding unit 50 that adsorbs and holds target wafer W from the bottom surface thereof, a second holding unit 51 that adsorbs and holds surface F_{S} of dicing frame F, and a third holding unit 52 that holds support wafer S in such a way that support wafer S rides third holding unit 52, are provided in the inside in processing chamber 40. First holding unit 50 and second holding unit 51 are installed in a place higher than third holding unit 52, respectively, and first holding unit 50 is disposed to face with third holding unit 52. That is, in the inside of processing chamber 40, the separating of complex target T is performed in a state where target wafer W is disposed in the upper side and support wafer S is disposed in the lower side.

First holding unit 50 has a substantially flat plate shape as illustrated in FIG. 5. A suction pipe 60 to adsorb and hold non-joint surface W_{N} of target wafer W through dicing tape P is provided within first holding unit 50. Suction pipe 60 is connected to a negative pressure generating device (not illustrated) such as, for example, a vacuum pump.

A heating mechanism 61 that heats target wafer W is provided within first holding unit 50. As heating mechanism 61, for example, a heater is used.

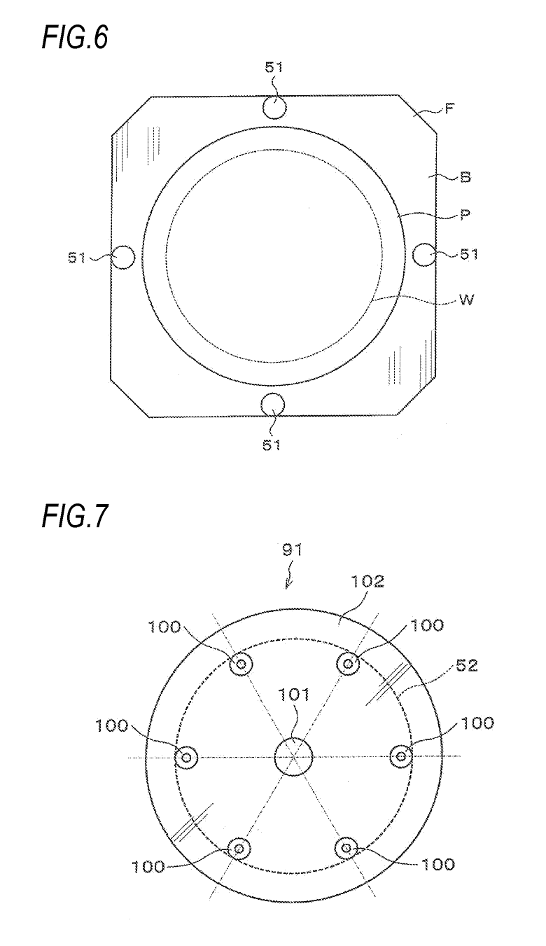

Second holding unit 51 is installed integrally with first holding unit 50 in the outer peripheral of first holding unit 50. That is, second holding unit 51 is disposed in the outer side of dicing tape P. Second holding unit 51 is connected to a negative pressure generating device (not illustrated) such as, for example, a vacuum pump, and may adsorb and hold surface F_{S} of dicing frame F in the outer side of dicing tape P. As illustrated in FIG. 6, second holding units 51 are installed at a plurality of portions, for example, four portions. Four second holding units 51 are disposed in each side of dicing frame F with an equal interval.

Herein, as described above, in the outer peripheral of dicing frame F, step B exists between dicing tape P. For that reason, when first holding unit 50 adsorbs and holds dicing frame F, a gap by step B is formed between first holding unit 50 and dicing frame F. That is, first holding unit 50 does not adsorb and hold dicing frame F, directly. In this case, dicing frame F does not fix, and thus target wafer W is not held properly by first holding unit 50. In this respect, in the present exemplary embodiment, dicing frame F is adsorbed and held by second holding unit 51, and thus target wafer W is also properly held by first holding unit 50.

Third holding unit 52 has a substantially flat plate shape as illustrated in FIG. 5. A suction pipe 70 that adsorbs and holds support wafer S is installed within third holding unit 52. Suction pipe 70 is connected to a negative pressure generating device (not illustrated) such as, for example, a vacuum pump. As third holding unit 52, for example, an aluminum which is an elastic body is used.

A heating mechanism 71 that heats support wafer S is provided in the inside of third holding unit 52. As heating mechanism 71, a heater made of, for example, an aluminum is used.

As illustrated in FIG. 4, a support plate 80 that supports first holding unit 50 is installed in the upper surface of first holding unit 50. Support plate 80 is supported on a ceiling surface of processing chamber 40. Support plate 80 of the present exemplary embodiment may be omitted and first holding unit 50 may contact with the ceiling surface of processing chamber 40 to be supported.

In the down side of third holding unit 52, a moving mechanism 90 is installed, which moves third holding unit 52 and support wafer S both in a vertical direction and a horizontal direction. Moving mechanism 90 includes: a first vertical moving unit 91 that holds third holding unit 52 and moves only the outer peripheral of third holding unit 52 in a vertical direction; a second vertical moving unit 92 that moves first vertical moving unit 91 and third holding unit 52 in a vertical direction; and a horizontal moving unit 93 that moves first vertical moving unit 91, second vertical moving unit 92 and third holding unit 52 in the horizontal direction. First vertical moving unit 91, second vertical moving unit 92, and horizontal moving unit 93 are arranged in this order from above.

First vertical moving unit 91 includes a plurality of, for example, six cylinders 100 that move the outer peripheral of third holding unit 52 in an annular shape in the vertical direction, a support column 101 that supports the center portion of third holding unit 52, and a support plate 102 that supports cylinders 100 and support column 101. As illustrated in FIG. 7, six cylinders 100 are arranged on the same circumference with support plate 102 with an equal interval. These cylinders 100 are disposed in positions corresponding to the outer peripheral of third holding unit 52. Support column 101 is disposed in a position that corresponds to the center portion of third holding unit 52 and is a center portion of support plate 102. That is, support column 101 is disposed such that the position of the center portion of third holding unit 52 in the vertical direction does not change when the outer peripheral of third holding unit 52 moves vertically and downwardly by cylinders 100.

As illustrated in FIG. 4, second vertical moving unit 92 includes a driving unit 110 that elevates support plate 102 and support members 111 that support support plate 102. Driving unit 110 includes, for example, a ball screw (not illustrated) and a motor (not illustrated) that rotates the ball screw. Support members 111 are configured to be freely stretchable in the vertical direction, and are installed in, for example, three positions between support plate 102 and horizontal moving unit 93.

Horizontal moving unit 93 includes, for example, a ball screw (not illustrated) and a motor (not illustrated) that rotates the ball screw, and may move first vertical moving unit 91, second vertical moving unit 92 and third holding unit 52 in the horizontal direction.

In the lower side of third holding unit 52, elevating pins (not illustrated) are installed, which support and elevate complex wafer T or support wafer S from below. Each of the elevating pins is configured such that the pin is inserted and penetrated through a through-hole (not illustrated) formed on third holding unit 52 to protrude from the upper surface of third holding unit 52.

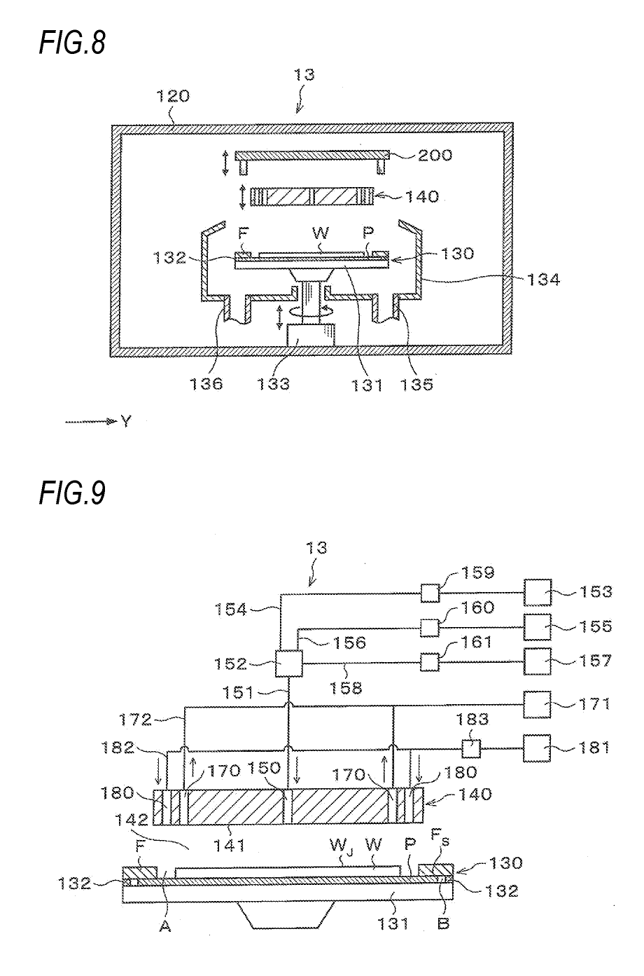

Next, the configuration of cleaning apparatus 13 as described above will be described. Cleaning apparatus 13 includes a processing chamber 120 as illustrated in FIG. 8. A carrying-in/out port (not illustrated) for target wafer W is formed in a lateral side of processing chamber 120, and the carrying-in/out port is provided with an opening/closing shutter (not illustrated). A filter (not illustrated) to purify the inner atmosphere of processing chamber 120 is installed within processing chamber 120. Target wafer W is held by dicing frame F and dicing tape P.

A wafer holding unit 130 as a rotation holding unit is installed in the center portion within processing chamber 120. As illustrated in FIG. 9, wafer holding unit 130 includes a spin chuck 131 that holds and rotates target wafer W through dicing tape P and adsorption pads 132 that adsorb and hold surface F_{S} of dicing frame F.

Spin chuck 131 has a horizontal upper surface, and the upper surface is provided with, for example, a suction port (not illustrated) that sucks dicing tape P. Spin chuck 131 is installed to cover at least target wafer W. Target wafer W may be adsorbed and held on spin chuck 131 through dicing tape P by the suction from the suction port. Target wafer W is adsorbed and held on spin chuck 131 such that joint surface W_{J} of target wafer W faces upward.

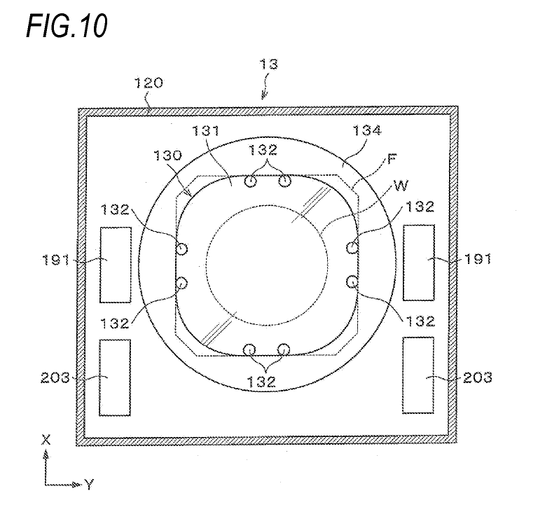

Adsorption pads 132 are installed on the outer peripheral of spin chuck 131. That is, adsorption pads 132 are disposed in the outer side of dicing tape P. Adsorption pads 132 are connected to a negative pressure generating device (not illustrated) such as, for example, a vacuum pump, and adsorption pads 132 may adsorb and hold surface F_{S} of dicing frame F in the outer side of dicing tape P. Meanwhile, as illustrated in FIG. 10, adsorption pads 132 may be installed in several positions, for example, eight positions.

Herein, as described above, in the outer peripheral of dicing frame F, step B exists between dicing tape P as illustrated in FIG. 9. For that reason, when spin chuck 131 adsorbs and holds dicing frame F, a gap by step B is formed between spin chuck 131 and dicing frame F. That is, spin chuck 131 does not adsorb and hold dicing frame F, directly. In this case, dicing frame F does not fix, and thus, target wafer W is not held properly by spin chuck 131. In this respect, in the present exemplary embodiment, dicing frame F is adsorbed and held by adsorption pads 132, and thus target wafer W is also properly held by wafer holding unit 130.

In the down side of wafer holding unit 130, as illustrated in FIG. 8, a chuck driving unit 133 is installed, which is a rotating mechanism including, for example, a motor. Spin chuck 131 may be rotated with a predetermined speed by chuck driving unit 133. Chuck driving unit 133 is provided with an elevation driving source such as, for example, a cylinder, and spin chuck 131 may be freely elevatable.

In the surrounding of wafer holding unit 130, a cup 134 is installed which receives and recovers the liquid scattered or dropped from target wafer W. A discharge pipe 135 that discharges the recovered liquid and an exhaust pipe 136 that exhausts such that the atmosphere within cup 134 is in a vacuum state, are connected to the bottom surface of cup 134.

A cleaning jig 140 that cleans joint surface W_{J} of target wafer W is installed above wafer holding unit 130. Cleaning jig 140 is disposed such that cleaning jig 140 is opposite to target wafer W held by wafer holding unit 130.

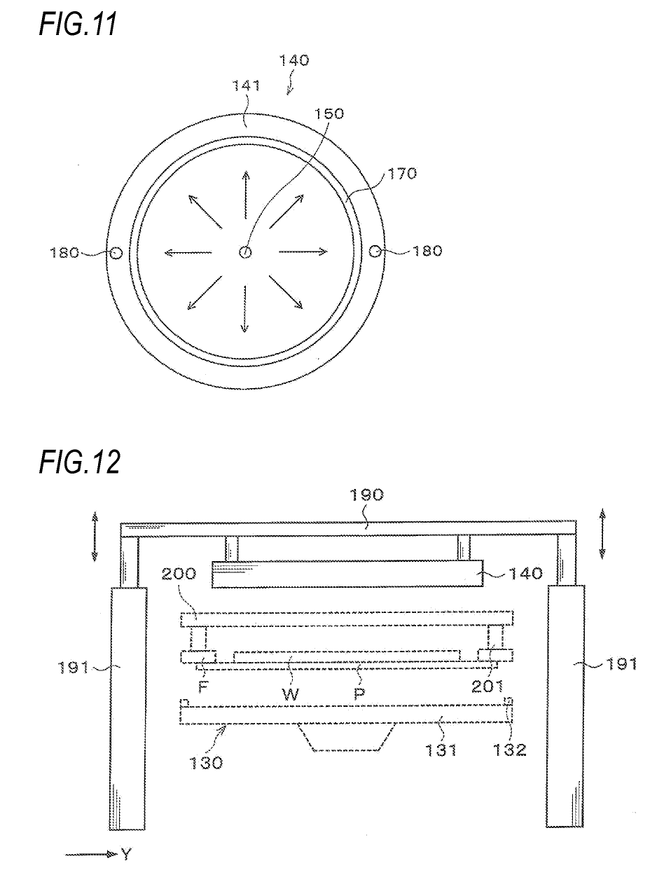

Cleaning jig 140 has a substantial circular plate shape as illustrated in FIGS. 9 and 11. In the bottom surface of cleaning jig 140, a supplying surface 141 is provided to cover at least joint surface W_{J} of target wafer W. In the present exemplary embodiment, supplying surface 141 and joint surface W_{J} have almost the same size.

As illustrated in FIG. 9, in the center portion of cleaning jig 140, a gas-liquid supplying unit 150 is installed supplying a solvent of adhesive G (an organic solvent), a rinse liquid of the solvent, and an inert gas with respect to a gap 142 between supplying surface 141 and joint surface W_{J}. Gas-liquid supplying unit 150 penetrates cleaning jig 140 in a thickness direction thereof. Gas-liquid supplying unit 150 serves as a cleaning liquid supplying unit that supplies a solvent and a rinse liquid which are a cleaning liquid, and gas-liquid supplying unit 150 in the present exemplary embodiment also supplies an inert gas, and thus is called as a gas-liquid supplying unit.

A supply pipe 151 is connected to gas-liquid supplying unit 150. Supply pipe 151 is provided with a valve 152 that switches the flows of the solvent of adhesive G, the rinse liquid of the solvent, and the inert gas. A supply pipe 154 that communicates with a solvent supply source 153 that stores the solvent therein, a supply pipe 156 that communicates with a rinse liquid supply source 155 that stores the rinse liquid therein, and a supply pipe 158 that communicates with an inert gas supply source 157 that stores an inert gas therein, are connected to valve 152. Each of supply pipes 154, 156, 158 is provided with supplying mechanism groups 159, 160, 161 each including, for example, a flow meter controller or a valve that controls the flow of the solvent, the rinse liquid, and the inert gas. As the solvent of adhesive G, for example, a thinner is used. As the rinse liquid, various liquids are used according to a main dissolvent component of adhesive G, and, for example, deionized water or isopropyl alcohol (IPA) is used. To facilitate the drying of the rinse liquid, a high volatile liquid may be used as the rinse liquid. As for the inert gas, for example, a nitride gas is used.

In the outer peripheral of cleaning jig 140, a suction unit 170 is installed serving as a cleaning liquid suction unit and sucks a cleaning liquid which is the solvent or the rinse liquid (mixed liquid as described below) supplied to gap 142. Suction unit 170 penetrates cleaning jig 140 in a thickness direction thereof and is formed in an annular shape along the outer peripheral of cleaning jig 140, as illustrated in FIG. 11. Suction pipes 172 communicated with a negative pressure generating device 171 such as, for example, a vacuum pump are connected to suction port 170, as illustrated in FIG. 9.

A gas supplying unit 180 that supplies a gas to step portion A is installed in the outer peripheral of cleaning jig 140, that is, in the outer side of suction unit 170. Gas supplying unit 180 penetrates cleaning jig 140 in a thickness direction thereof. A plurality of, for example, two gas supplying units 180 are formed in the outer peripheral of cleaning jig 140, as illustrated in FIG. 11. A supply pipe 182 communicated with a gas supply source 181 that stores a gas such as, for example, a dried air or an inert gas therein, is connected to each of gas supplying units 180 as illustrated in FIG. 9. Supplying mechanism group 183 including a valve or a flow meter controller that controls the flow of a gas is installed in supply pipe 182.

Cleaning jig 140 is supported by a support member 190 that extends in the Y-direction, as illustrated in FIG. 12. Elevating mechanisms 191, 191 that elevate support member 190 in the vertical direction are installed in both ends of support member 190. As for elevating mechanism 191, for example, a cylinder is used. Elevating mechanism 191 is disposed in the outer side of cup 134, as illustrated in FIG. 10.

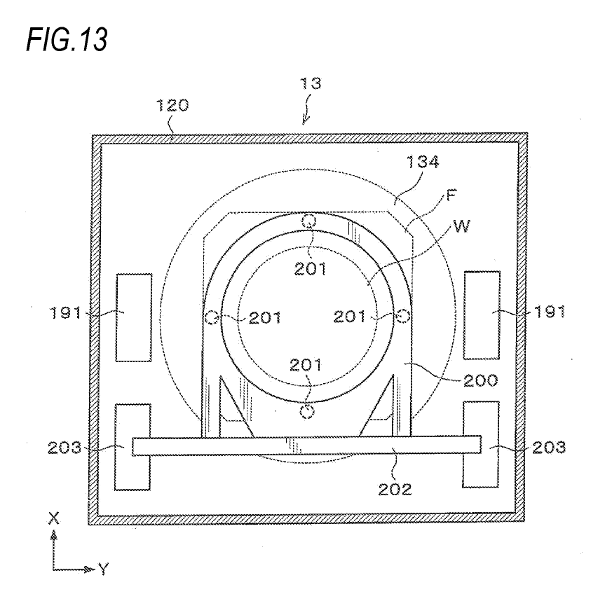

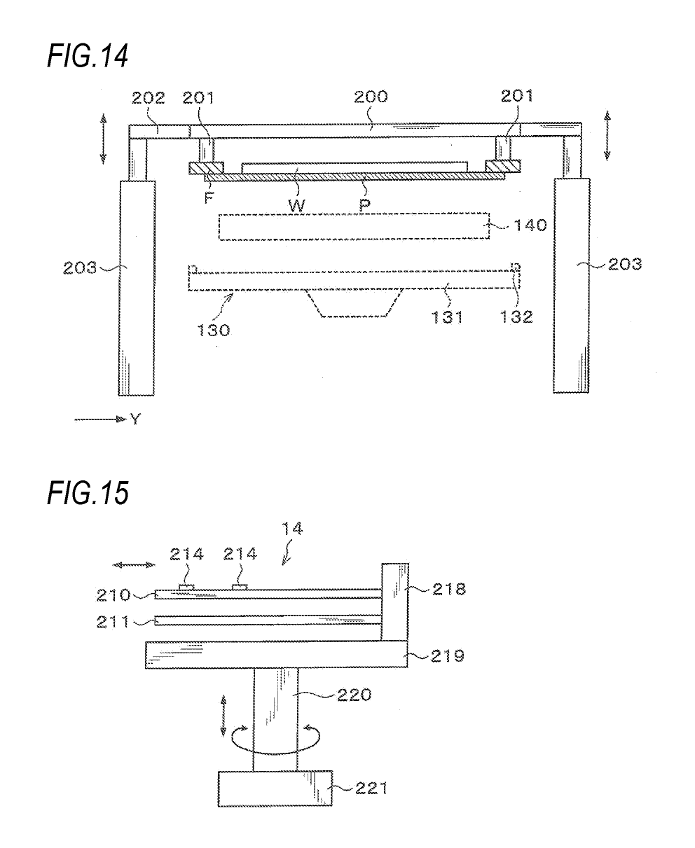

As illustrated in FIG. 8, a transfer arm 200 that transfers target wafer W from transporting device 14 to wafer holding unit 130 is installed above wafer holding unit 130 in addition to cleaning jig 140 as described above. Transfer arm 200 has an annular shape to hold the outer peripheral of dicing frame F, as illustrated in FIGS. 13 and 14. In the bottom surface of transfer arm 200, a plurality of, for example, four frame holding units 201 are formed. A negative pressure generating device (not illustrated) such as, for example, a vacuum pump is connected to each of frame holding units 201, and frame holding units 201 may adsorb and hold dicing frame F attached with target wafer W.

Transfer arm 200 is supported by a support member 202 which extends in the Y-direction. Elevating mechanisms 203, 203 that elevate support member 202 in the vertical direction are installed in both ends of support member 202. As elevating mechanism 203, for example, a cylinder is used. Each of elevating mechanisms 203 is disposed at a minus side of elevating mechanism 191 in the X-direction.

Next, the configuration of transporting device 14 as described above will be described. Transporting device 14 includes, as illustrated in FIG. 15, a first transporting arm 210 that holds and transports complex wafer T or target wafer W, and a second transporting arm 211 that holds and transports support wafer S. Each of complex wafer T and target wafer W transported by first transporting arm 210 is held by dicing frame F and dicing tape P.

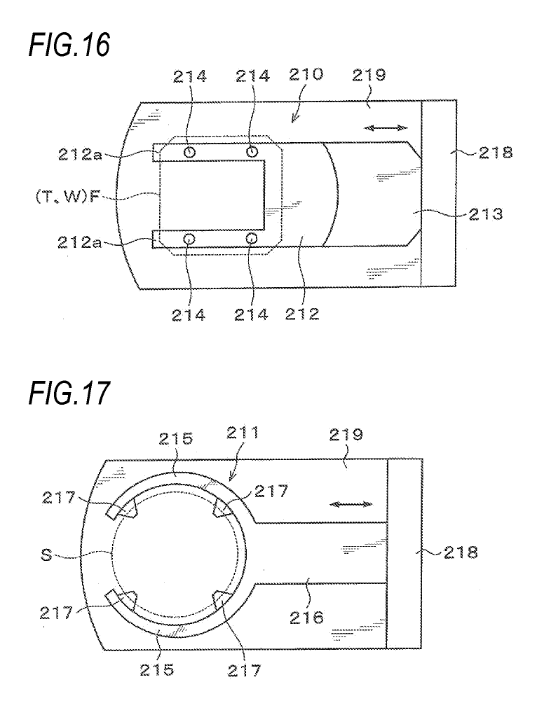

First transporting arm 210 includes, as illustrated in FIG. 16, an arm portion 212 of which front end is branched to two front end portions 212a, 212a, and a support portion 213 that is integrally formed with arm portion 212 and supports arm portion 212. Each of front end portions 212a of arm portion 212 is provided with adsorption pads 214 that adsorb and hold complex wafer W or target wafer W via dicing frame F or dicing tape P. First transporting arm 210 may hold complex wafer T or target wafer W on arm portion 212 horizontally.

Second transporting arm 211 includes, as illustrated in FIG. 17, an arm portion 215 that is formed in a ¾ annular shape having a diameter larger than support wafer S, and a support portion 216 that is integrally formed with arm portion 215 and supports arm portion 215. A plurality of, for example, four holding portions 217 that protrude toward the inner side and hold the corner portions of support wafer S are formed in arm portion 215. Second transporting arm 211 may hold support wafer S on holding portions 217 horizontally.

As illustrated in FIG. 15, an arm driving unit 218 is installed in a base end portion of each of transporting arms 210, 211. Each of transporting arms 210, 211 may move independently in a horizontal direction using arm driving unit 218. These transporting arms 210, 211 and arm driving unit 218 are supported by a base 219. In the lower surface of base 219, a rotation driving unit 221 is installed through a shaft 220. By rotation driving unit 221, base 219 and transporting arms 210, 211 may rotate around shaft 220 as a central axis and may elevate.

In separation system 1 as described above, a control unit 250 is installed as illustrated in FIG. 1. Control unit 250 is, for example, a computer, and has a program storing unit (not illustrated). A program which controls the processing of target wafer W, support wafer S, complex wafer T in separation system 1, is stored in the program storing unit. Further, a program which controls the operations of a driving system such as, for example, various processing apparatus or transporting device as described above to execute a separating in separation system 1 as described below, is stored in the program storing unit. The programs are recorded in a computer-readable storage medium H such as, for example, a hard disc HD, a flexible disc FD, a compact disc CD, a magnet optical disc MO and a memory card being readable by a computer, and the programs may be installed from storage medium H to control unit 250.

Next, a separating method of target wafer W and support wafer S performed using separation system 1 as described above will be described.

First, cassette C_{T} received with several complex wafers T and empty cassette C_{W} are disposed in a predetermined cassette disposing plate 21 of first carrying-in/out station 10. Empty cassette C_{S} is disposed in a predetermined cassette disposing plate 31 of second carrying-in/out station 11. Then, complex wafer T within cassette C_{T} is drawn out by first transporting arm 210 to be transported to separating apparatus 12. At this time, complex wafer T is transported in a state where complex wafer T is held by dicing frame F and dicing tape P, target wafer W is disposed in the upper side, and support wafer S is disposed in the lower side.

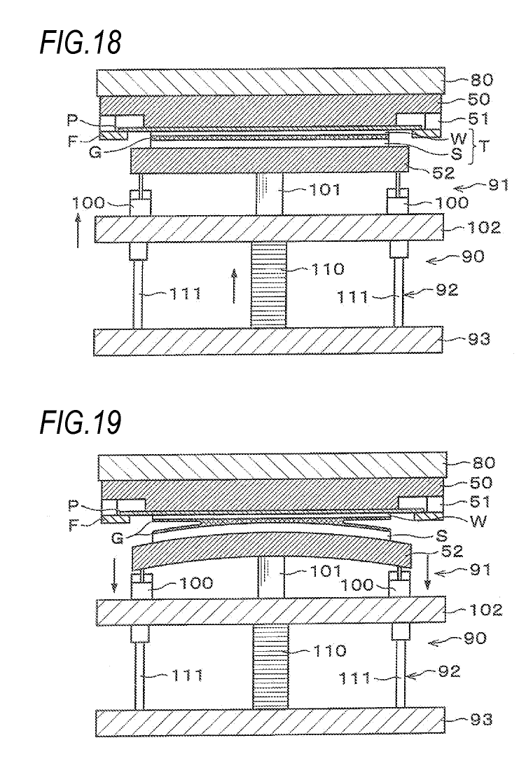

Complex wafer T carried-in to separating apparatus 12 is adsorbed and held by third holding unit 52. Then, as illustrated in FIG. 18, second vertical moving unit 92 of moving mechanism 90 lifts third holding unit 52, and thus, complex wafer T is held by being sandwiched between first holding unit 50 and third holding unit 52. At this time, first holding unit 50 adsorbs and holds non-joint surface W_{N} of target wafer W through dicing tape P, second holding unit 51 adsorbs and holds surface F_{S} of dicing frame F, and third holding unit 52 adsorbs and holds non-joint surface S_{N} of support wafer S.

Then, complex wafer T is heated to a predetermined temperature, for example, 200 by heating mechanisms 61, 71. As a result, adhesive G within complex wafer T is softened.

Then, as illustrated in FIG. 19, first vertical moving unit 91 of moving mechanism 90 moves only the outer peripheral of third holding unit 52 vertically and downwardly in an annular shape while the softening state of adhesive G is maintained by heating complex wafer T using heating mechanisms 61, 71. That is, the center portion of third holding unit 52 is supported by support column 101 and the position of the center portion of third holding unit 52 in the vertical direction does not change when the outer peripheral of third holding unit 52 moves vertically and downwardly by cylinders 100.

In this case, support wafer S held by third holding unit 52 is continuously separated from target wafer W held by first holding unit 50 and second holding unit 51 toward the center portion from the outer peripheral support wafer S. Herein, as described above, since joint surface W_{J} is provided with electronic circuits, when target wafer W is separated from support wafer S at a time, a large load is applied to joint surfaces W_{J}, S_{J} and the electronic circuits may be damaged. In this regard, in the present exemplary embodiment, support wafer S is continuously separated from target wafer W from the outer peripheral toward the center portion, and thus, a large load is not applied to joint surfaces W_{J}, Sⱼ. Therefore, the damage of the electronic circuits may be suppressed.

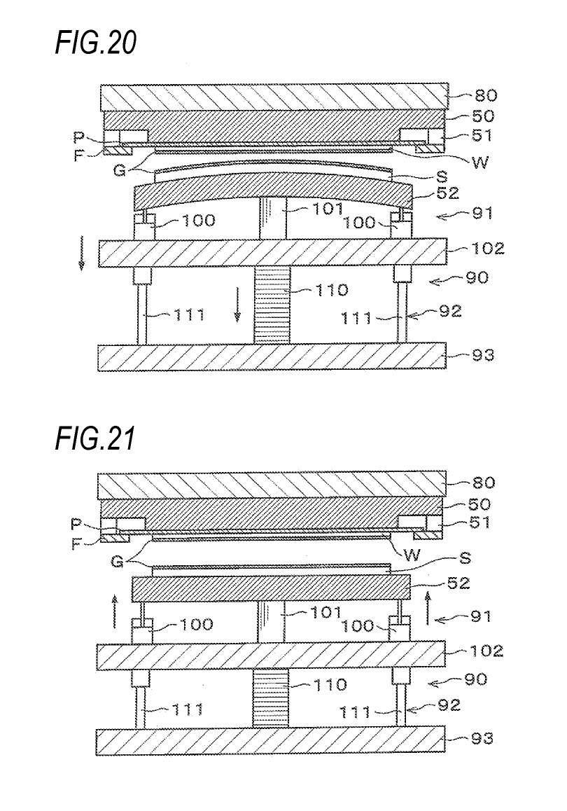

Next, as illustrated in FIG. 20, second vertical moving unit 92 moves entire third holding unit 52 vertically and downwardly in a state where only the center portion of support wafer S and the center portion of target wafer W is bonded. And, support wafer S is separated from target wafer W in a state where the outer peripheral of support wafer S is bent vertically and downwardly. Then, as illustrated FIG. 21, the outer peripherals of support wafer S and third holding unit 52 are moved vertically and upwardly by first vertical moving unit 91, and thus, third holding unit 52 and support wafer S are flattened. As a result, target wafer W held by first holding unit 50 and second holding unit 51 is separated from support wafer S held by third holding unit 52.

Then, target wafer W separated by separating apparatus 12 is transported to reversing device 32 by first transporting arm 210 of transporting device 14, and the front/rear surfaces of target wafer W is reversed in reversing device 32. That is, joint surface W_{J} of target wafer W faces upwardly. Then, target wafer W is transported to cleaning apparatus 13 by first transporting arm 210 of transporting device 14. Target wafer W carried-out from separating apparatus 12 and carried-in to cleaning apparatus 13 is held by dicing frame F and dicing tape P.

Support wafer S separated by separating apparatus 12 is transported to cassette C_{S} of second carrying-in/out station 11 by second transporting arm 211 of transporting device 14. Then, support wafer S is carried-out from second carrying-in/out station 11 to be recovered. The timing when support wafer S is transported to second carrying-in/out station 11 may be set arbitrarily. The transportation of support wafer S may be performed, for example, before target wafer W is transported to reversing device 32, during the reversing of target wafer W in reversing device 32, or after target wafer W is transported to cleaning apparatus 13.

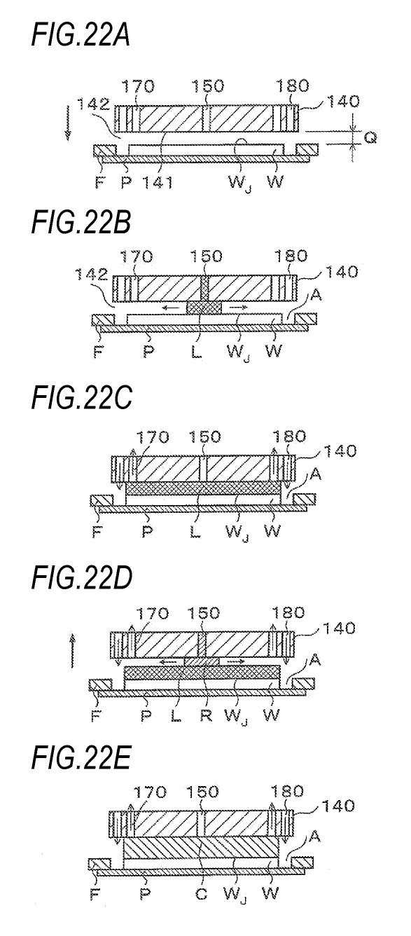

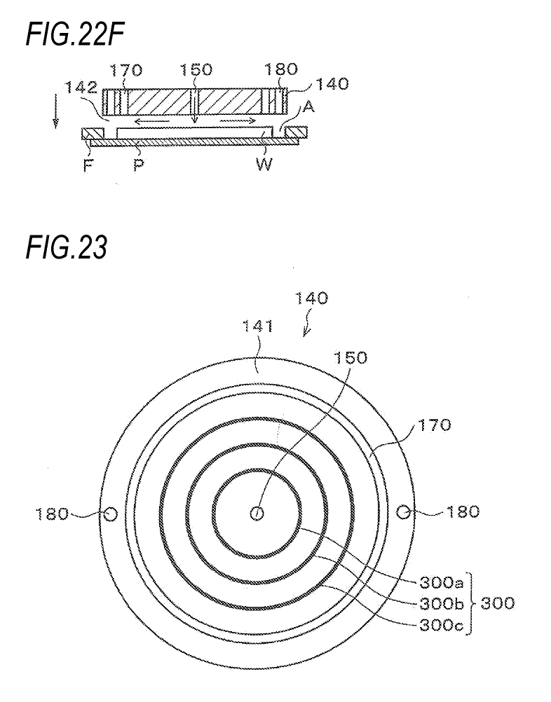

Target wafer W carried-in to cleaning apparatus 13 is transferred to transfer arm 200 from first transporting arm 210 of transporting device 14. Target wafer W is transferred to wafer holding unit 130 by transfer arm 200, and held by wafer holding unit 130. Specifically, target wafer W is adsorbed and held on spin chuck 131 through dicing tape P. At the same time, surface F_{S} of dicing frame F is adsorbed and held on adsorption pads 132. As illustrated in FIG. 22A, cleaning jig 140 descends to a predetermined position by elevating mechanism 191. At this time, cleaning jig 140 is disposed such that supplying surface 141 of cleaning jig 140 and joint surface W_{J} of target wafer W face with each other. A predetermined distance Q between supplying surface 141 and joint surface W_{J} may be a distance capable of diffusing the solvent of adhesive G by the surface tension in gap 142 between supplying surface 141 and joint surface W_{J}, as described below.

Then, as illustrated in FIG. 22B, a solvent L is supplied to gas-liquid supplying unit 150 from solvent supply source 153 while rotating target wafer W by spin chuck 131. Target wafer W is rotated with 50 rpm, which is a low speed. Solvent L is supplied from gas-liquid supplying unit 150 to gap 142 between supplying surface 141 and joint surface W_{J}, and diffused on joint surface W_{J} of target wafer W by a centrifugal force caused by the rotation of target wafer W in gap 142. On investigation by the inventors, even when target wafer W is rotated with 50 rpm, which is a low speed, solvent L may fully diffuse on joint surface W_{J}. As illustrated in FIG. 22C, solvent L in gap 142 is supplied to the entire surface of joint surface W_{J} of target wafer W.

When a gap between joint surface W_{J} of target wafer W and supplying surface 141 is maintained to predetermined distance Q, as described above, solvent L in gap 142 is diffused on joint surface W_{J} by the surface tension of solvent L. In this case, two external forces of the centrifugal force and the surface tension are applied to solvent L, and thus, solvent L may be diffused more smoothly.

In this way, when solvent L is diffused on joint surface W_{J}, target wafer W is rotated with 50 rpm, which is a low speed, and thus, the introduction of solvent L to step portion A is suppressed. When solvent L is supplied to gap 142 from gas-liquid supplying unit 150 to be diffused on joint surface WJ, as described above, solvent L is sucked by suction unit 170 and a gas is supplied to step portion A from gas supplying unit 180. And then, the introduction of solvent L to step portion A is further suppressed. For that reasons, the damaging of dicing tape P in step portion A may be suppressed.

Then, a state where joint surface W_{J} of target wafer W is dipped in solvent L is maintained for a predetermined time period, for example, for several minutes, and then impurities such as, for example, adhesive G that remains on joint surface W_{J} are removed by solvent L.

Then, an inert gas is supplied to gas-liquid supplying unit 150 from inert gas supply source 157. Solvent L within gas-liquid supplying unit 150 is discharged by the inert gas.

Then, as illustrated in FIG. 22D, cleaning jig 140 ascends to a position capable of supplying a rinse liquid R to gap 142 while target wafer W is continuously rotated by spin chuck 131. Then, rinse liquid R is supplied to gas-liquid supplying unit 150 from rinse liquid supply source 155. Rinse liquid R is diffused on joint surface W_{J} of target wafer W in gap 142 by the centrifugal force (and the surface tension) while rinse liquid R is supplied to gap 142 from gas-liquid supplying unit 150 to be mixed with solvent L. As illustrated in FIG. 22E, a mixed liquid C of solvent L and rinse liquid R in gap 142 is supplied to the entire surface of joint surface W_{J} of target wafer W.

When rinse liquid R is supplied to gap 142 from gas-liquid supplying unit 150 to be diffused on joint surface W_{J}, as described above, mixed liquid C (solvent L and rinse liquid R) is sucked by suction unit 170 and a gas is supplied to step portion A from gas supplying unit 180. And then, the introduction of mixed liquid C to step portion A is suppressed.

Then, as illustrated in FIG. 22F, cleaning jig 140 descends to a predetermined position while target wafer W is continuously rotated by spin chuck 131. Then, an inert gas is supplied to gap 142 from inert gas supply source 157 through gas-liquid supplying unit 150. By the inert gas, mixed liquid C being filled in gap 142 is flowed to the outer peripheral side of target wafer W to be sucked by suction unit 170. As a result, mixed liquid C in gap 142 is removed.

The cleaning jig 140 is descended when the inert gas is supplied to gap 142 as described above in order to make the flow rate of the inert gas fast by reducing the distance in the vertical direction of gap 142. Therefore, mixed liquid C in gap 142 may be quickly removed.

Even after mixed liquid C in gap 142 is removed, the rotation of target wafer W by spin chuck 131 and the supplying of the inert gas to gap 142 are continuously performed. Then, joint surface W_{J} of target wafer W is dried. As such, joint surface W_{J} of target wafer W is cleaned in cleaning apparatus 13.

Then, target wafer W cleaned in cleaning apparatus 13 is transported to cassette C_{W} of first carrying-in/out station 10 by first transporting arm 210 of transporting device 14. Then, target wafer W is carried-out from first carrying-in/out station 10 to be recovered. Therefore, a series of separating of target wafer W and support wafer S in separation system 1 is completed.

According to exemplary embodiments as described above, solvent L is supplied from gas-liquid supplying unit 150 to gap 142 between supplying surface 141 and joint surface W_{J}, and the supplied solvent L is diffused on joint surface W_{J} while target wafer W is rotated. And then, joint surface W_{J} of target wafer W may be cleaned by solvent L. At this time, target wafer W is rotated with 50 rpm, which is a low speed, and thus, the introduction of solvent L to step portion A is suppressed. Moreover, when solvent L is supplied to gap 142 from gas-liquid supplying unit 150 to be diffused on joint surface W_{J}, as described above, solvent L is sucked by suction unit 170 and gas is supplied to step portion A from gas supplying unit 180. And then, the introduction of solvent L to step portion A is further suppressed. Therefore, joint surface W_{J} of target wafer W may be cleaned properly while suppressing the damage of dicing tape P in step portion A. In the present exemplary embodiment, since solvent L is not diffused to an area beside joint surface W_{J} of target wafer W, the supplying amount of solvent L may be suppressed to a small amount to save the cost of solvent L.

Herein, once solvent L is introduced to step portion A, solvent L is hardly discharged from step portion A. As a result, since step portion A is difficult to be dried, it takes a time to clean joint surface W_{J} of target wafer W. In this regard, in the present exemplary embodiment, the introduction of solvent L to step portion A is suppressed, and thus, the cleaning of joint surface W_{J} may be quickly performed.

When joint surface W_{J} of target wafer W is cleaned, since rinse liquid R is supplied to gap 142 after solvent L is supplied to gap 142, adhesive G on joint surface W_{J} may be removed by rinse liquid R to clean joint surface W_{J} of target wafer W properly.

Furthermore, when joint surface W_{J} of target wafer W is cleaned, since the inert gas is supplied to gap 142 after rinse liquid R is supplied to gap 142, joint surface W_{J} of target wafer W may be dried appropriately.

In the exemplary embodiments as described above, the suction of solvent L and mixed liquid C by suction unit 170 may be performed in a state where the rotation of target wafer W is stopped. Specifically, as illustrated in FIG. 22B, solvent L is diffused on joint surface W_{J} while target wafer W is rotated with 50 rpm. As illustrated in FIG. 22C, when solvent L is diffused to the entire surface of joint surface W_{J}, the rotation of target wafer W is stopped to suck solvent L by suction unit 170. In this case, since the rotation of target wafer W is stopped, solvent L is diffused no more. Therefore, solvent L is effectively sucked by suction unit 170, and thus, the introduction of solvent L into step portion A may be further suppressed. Meanwhile, a case where mixed liquid C is sucked by suction unit 170 is the same as the suction of solvent L as described above, and the description thereof will be omitted.

In supplying surface 141 of cleaning jig 140 in the exemplary embodiment as described above, as illustrated in FIG. 23, recess portions 300 may be formed. Recess portions 300 are formed at a plurality of, for example, three positions which are inner side of suction unit 170 in a concentric circle shape with supplying surface 141. In this case, when solvent L is diffused in gap 142, solvent L is diffused on joint surface W_{J} for each of recess portions 300. Specifically, solvent L supplied from gas-liquid supplying unit 150 to gap 142 is diffused up to the inmost recess portion 300a. And, the inside of recess portion 300a is filled with solvent L. Then, solvent L is diffused to next recess portion 300b and is diffused in sequential up to outmost recess portion 300c. As described above, solvent L is diffused for each of recess portions 300, and thus solvent L may be diffused on joint surface W_{J} evenly and smoothly. Similarly, rinse liquid R is also diffused on joint surface W_{J} for each of recess portions 300 to be diffused on joint surface W_{J} evenly and smoothly. Therefore, joint surface W_{J} of target wafer W may be cleaned more properly.

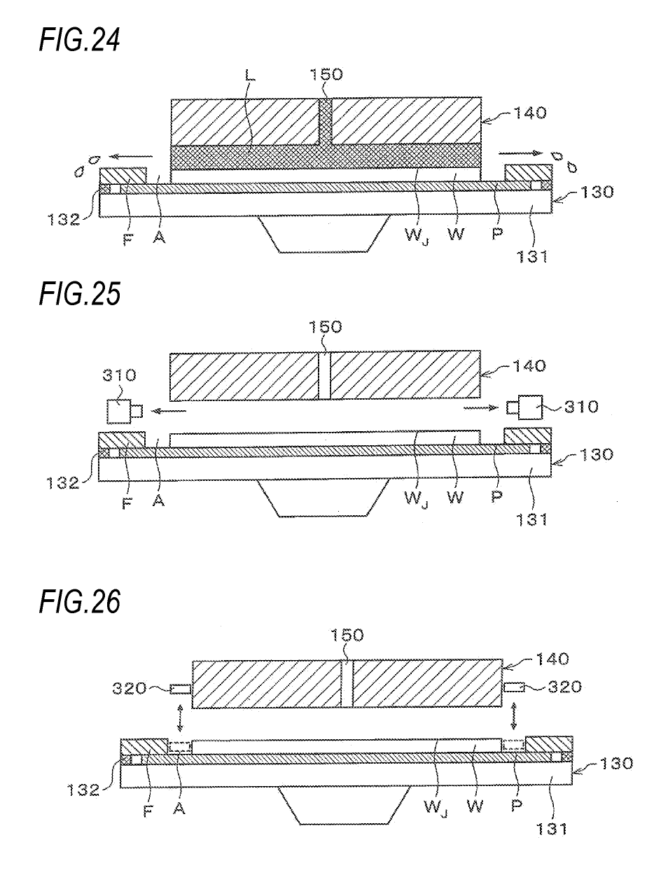

In the exemplary embodiments as described above, when solvent L or rinse liquid R is diffused on joint surface W_{J}, target wafer W is rotated with 50 rpm, which is a low speed. However, target wafer W may be rotated with 1000 rpm to 2000 rpm, which is a high speed. On investigation by the inventors, when target wafer W is rotated with 1000 rpm to 2000 rpm, which is a high speed, as described above, solvent L diffused in gap 142 may scatter to the outside of gap 142, as illustrated in FIG. 24. Further, solvent L is not introduced to step portion A but is scattered to the outside of dicing frame F, by the centrifugal force of the high speed rotation. Similarly, mixed liquid C is not introduced to step portion A but is scattered to the outside of dicing frame F, by the centrifugal force of the high speed rotation. Therefore, the damaging of dicing tape P in step portion A may be further suppressed.

When target wafer W is rotated with a high speed as described above, since the introduction of solvent L to step portion A may be suppressed by the centrifugal force of the high speed rotation, gas supplying unit 180 in cleaning jig 140 in the exemplary embodiments as described above may be omitted. In this case, cleaning jig 140 and target wafer W may be formed in the same size when viewed from above.

Similarly, since the introduction of solvent L to step portion A can be suppressed, suction unit 170 in cleaning jig 140 in the exemplary embodiments as described above may be omitted.

Instead of suction unit 170, as illustrated in FIG. 25, in cleaning jig 140, suction unit 310 as a cleaning liquid suction unit that sucks solvent L or mixed liquid C supplied to gap 142 may be provided in the outside of step portion A. Suction unit 310 is formed in an annular shape along, for example, the outer peripheral of cleaning jig 140. In this case, solvent L or mixed liquid C scattered to the outside from gap 142 is passed above step portion A to be sucked by suction unit 310. For that reason, the introduction of solvent L or mixed liquid C to step portion A may be further suppressed. Therefore, the damaging of dicing tape P in step portion A may be further suppressed.

In cleaning jig 140 in the exemplary embodiment as described above, as illustrated in FIG. 26, a cover 320 may be formed. Cover 320 is formed in an annular shape along, for example, the outer peripheral of cleaning jig 140 and above step portion A. Cover 320 is configured to be freely movable forwardly and backwardly with respect to step portion A and be freely movable in the vertical direction by a moving mechanism (not illustrated). Cover 320 may cover dicing tape P in step portion A. In this case, even when solvent L or mixed liquid C leaked from gap 142 is introduced slightly to step portion A, the introduction of solvent L or mixed liquid C onto dicing tape P in step portion A may be suppressed by cover 320. Therefore, the damaging of dicing tape P as described above may be further suppressed.

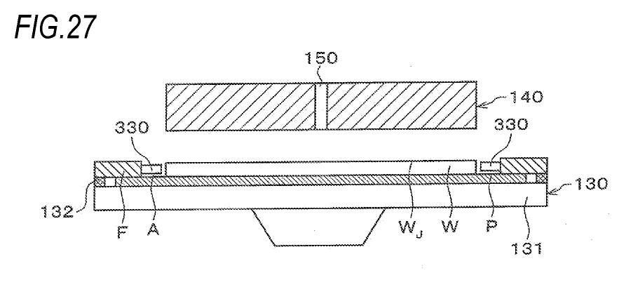

In dicing frame F in the exemplary embodiment as described above, a protrusion 330 may be provided as illustrated in FIG. 27. Protrusion 330 protrudes from the outer surface of dicing frame F toward inner side in step portion A. Protrusion 330 is formed as an annular shape along the outer peripheral of dicing frame F and covers dicing tape P in step portion A. In this case, even when, for example, solvent L or mixed liquid C leaked from gap 142 is introduced slightly to step portion A, the introduction of solvent L or mixed liquid C onto dicing tape P in step portion A may be suppressed by protrusion 330. Therefore, the damaging of dicing tape P as described above may be further suppressed.

Cover 320 and protrusion 330 may be provided in both sides along the space of step portion A. In FIGS. 26 and 27, even though suction units 170, 310 and gas supplying unit 180 are omitted, the suction units and the gas supplying unit may be installed as necessary.

In cleaning apparatus 13 in the present exemplary embodiments as described above, target wafer W is rotated by spin chuck 131, but cleaning jig 140 may be rotated instead. In this case, cleaning apparatus 13 is provided with a rotating mechanism (not illustrated) to rotate cleaning jig 140. Otherwise, cleaning jig 140 and target wafer W held by spin chuck 131 may be rotated together. In any case, cleaning jig 140 and target wafer W are rotated relatively to each other, and thus, solvent L or mixed liquid C may diffuse on joint surface W_{J} of target wafer W by the centrifugal force.

In cleaning apparatus 13 in the exemplary embodiments as described above, even though solvent L, rinse liquid R and the inert gas are used to clean joint surface W_{J} of target wafer W, rinse liquid R and the inert gas may be omitted when solvent L has a high volatility.

In separating apparatus 12 in the exemplary embodiments as described above, even though heating mechanism 61, 71 are installed within first holding unit 50 and third holding unit 52, respectively, heating mechanisms 61, 71 may be omitted. In this case, when complex wafer T is separated into target wafer W and support wafer S, complex wafer T is not heated and is maintained to a room temperature. Even in this case, as described above, support wafer S may be continuously separated from target wafer W. On the kinds of adhesive G, one in which the heating is not necessary to soften adhesive G exists, and in this case, the present exemplary embodiment is particularly useful.

The separating of complex wafer T in the exemplary embodiments as described above may be performed with a separation system which is different from separation system 1 as described above.

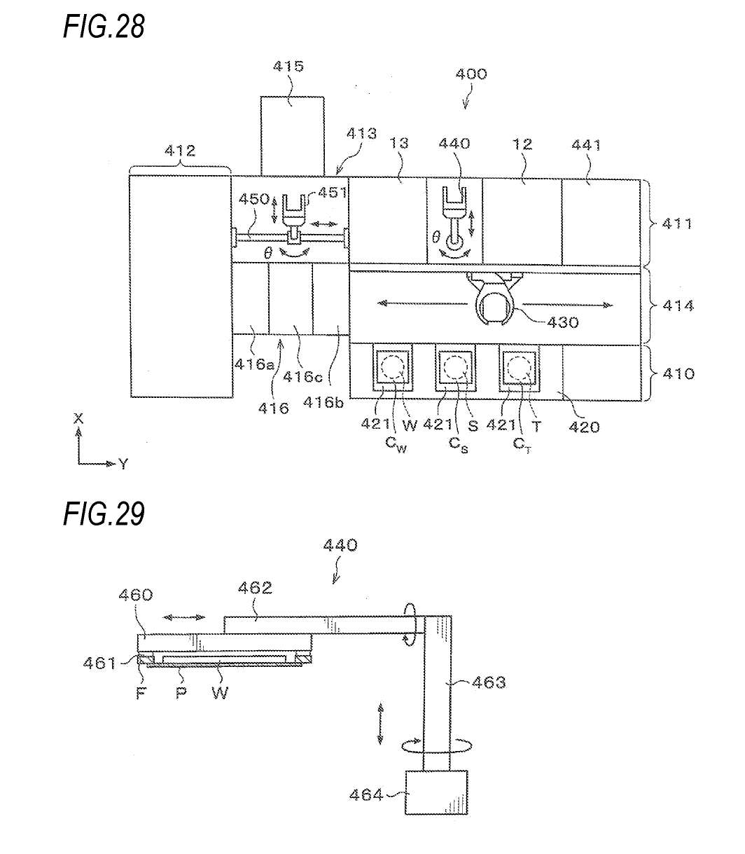

For example, a separation system 400 as illustrated in FIG. 28 includes a configuration in which a carrying-in/out station 410 where cassettes C_{W}, C_{S}, C_{T} capable of receiving a plurality of target wafers W, a plurality of support wafers S, and a plurality of complex wafers T are carried-in/out with respect to the outside; a processing station 411 including various processing apparatuses that perform a predetermined processing with respect to target wafer W, support wafer S, complex wafer T; and an interface station 413 that transfers target wafer W between processing station 411 and a post-processing station 412 adjacent to processing station 411, are integrally connected. In the present exemplary embodiment, each of target wafer W and complex wafer T is held by dicing frame F and dicing tape P.

Carrying-in/out station 410 and processing station 411 are disposed side by side in the X-direction (the top-bottom direction in FIG. 28). A wafer transport area 414 is formed between carrying-in/out station 410 and processing station 411. Interface station 413 is disposed in a minus side of processing station 411 in the Y-direction (left direction in FIG. 28). In a plus side of interface station 413 in the X-direction (up direction in FIG. 28), an inspecting device 415 is disposed which inspects target wafer W before target wafer is transferred to post-processing station 412. In the opposite side of inspecting device 415 with interface station 413 therebetween, that is, in a minus side of interface station 413 in the X-direction (down direction in FIG. 28), a post inspection cleaning apparatus 416 that cleans target wafer W after inspecting is disposed.

Carrying-in/out station 410 is provided with a cassette disposing table 420. Cassette disposing table 420 is provided with, a plurality of, for example, three cassette disposing plates 421. Cassette disposing plates 421 are disposed side by side in the Y-direction (left and right direction in FIG. 28). Cassettes C_{W}, C_{S}, C_{T} may be disposed in cassette disposing plates 421 when cassettes C_{W}, C_{S}, C_{T} are carried-in/out with respect to the outside of separation system 400. As such, carrying-in/out station 410 is constructed to retain the plurality of target wafers W, the plurality of support wafers S and the plurality of complex wafers T. The number of cassette disposing plates 421 is not limited to the present exemplary embodiment, but may be set arbitrarily. The plurality of complex wafers T carried-in to carrying-in/out station 410 is inspected in advance to be distinguished between complex wafers T including normal target wafers W and complex wafers T including defect target wafers W.

A first transporting device 430 is disposed in a wafer transporting area 414. First transporting device 430 includes two transporting arms which are freely movable in, for example, the vertical direction and the horizontal direction (Y-direction, X-direction) and around the vertical axis. These two transporting arms have the same configuration as first transporting arm 210 that holds and transports complex wafer T or target wafer W, and second transporting arm 211 that holds and transports support wafer S in the exemplary embodiments as described above, respectively. First transporting device 430 may move within wafer transporting area 414 to transport target wafer W, support wafer s, complex wafer T between carrying-in/out station 410 and processing station 411.

Processing station 411 includes a separating apparatus 12 that separates complex wafer T into target wafer W and support wafer S. In a minus side of separating apparatus 12 in the Y-direction (left direction in FIG. 28), a first cleaning apparatus 13 that cleans the separated target wafer W is disposed. A second transporting device 440 is installed between separating apparatus 12 and first cleaning apparatus 13. Further, in the plus side of separating apparatus 12 in the Y-direction, a second cleaning apparatus 441 is disposed as another cleaning apparatus that cleans the separated support wafer S. As described above, first cleaning apparatus 13, second transporting device 440, separating apparatus 12, second cleaning apparatus 441 are arranged in this order from interface station 413 side in processing station 411. Separating apparatus 12 has the same configuration as separating apparatus 12 in separation system 1 in the exemplary embodiment as described above. First cleaning apparatus 13 has the same configuration as cleaning apparatus 13 in separating system 1, but is called as first cleaning apparatus 13 for convenience sake so as to distinguish with second cleaning device 441.

In inspecting device 415, it is inspected whether the residue of adhesive G remains on target wafer W separated by separating apparatus 12. In post inspection cleaning apparatus 416, the cleaning of target wafer W in which the residue of adhesive G is inspected in inspecting device 415, is performed. Post inspection cleaning apparatus 416 includes a joint surface cleaning unit 416a that cleans joint surface W_{J} of target wafer W, a non-joint surface cleaning unit 416b that cleans non-joint surface W_{N} of target wafer W, and a reversing unit 416c that reverses target wafer W upwardly and downwardly. Joint surface cleaning unit 416a and non-joint surface cleaning unit 416b have the same configuration as first cleaning apparatus 13.

A third transporting device 451 being freely movable on transporting path 450 that extends in the Y-direction is installed in interface station 413. Third transporting device 415 may move in the vertical direction and around the vertical axis (0 direction), and may transport target wafer W between processing station 411, post-processing station 412, inspecting device 415 and post inspection cleaning apparatus 416.

In post-processing station 412, a predetermined post-processing is performed for target wafer W separated in processing station 411. As the predetermined post-processing, for example, a processing is performed in which the electrical characteristics of a device on target wafer W is inspected.

Next, the configuration of second transporting device 440 as described above will be described. Second transporting device 440 includes a transporting arm 460 that holds and transports target wafer W, as illustrated in FIG. 29. Target wafer W transported by transporting arm 460 is held by dicing frame F and dicing tape P.

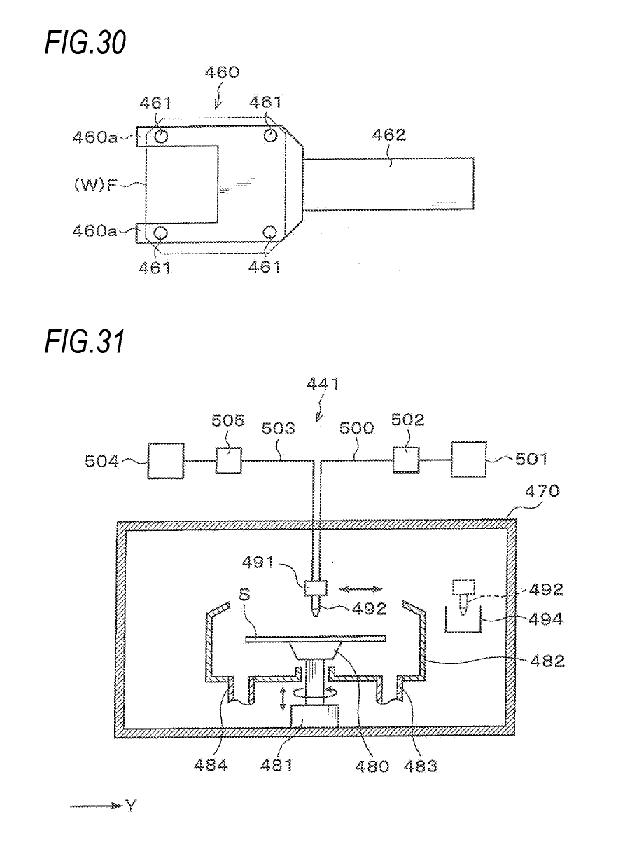

As illustrated in FIG. 30, transporting arm 460 has a shape where the front end thereof is branched into two front end portions 460a, 460a. Transporting arm 460 is provided with adsorption pads 461 that adsorb and hold target wafer W via dicing frame F (or dicing tape P). Therefore, transporting arm 460 may hold target wafer W on transporting arm 460 horizontally.

Transporting arm 460 is supported by a support arm 462 as illustrated in FIG. 29. Support arm 462 is supported by a first driving unit 463. Support arm 462 may rotate around a horizontal axis and may stretch in the horizontal direction by first driving unit 463. A second driving unit 464 is installed below first driving unit 463. First driving unit 463 may rotate around a vertical axis and may elevate in the vertical direction by second driving unit 464.

A third transporting device 451 has the same configuration as second transporting device 440 as described above. However, second driving unit 464 of third transporting device 451 is attached to transporting path 450, and thus, third transporting device 451 may move on transporting path 450.

Next, the configuration of second cleaning apparatus 441 as described above will be described. Second cleaning apparatus 441 includes a processing chamber 470 as illustrated in FIG. 31. A carrying-in/out port (not illustrated) for support wafer S is formed in a lateral side of processing chamber 470, and the carrying-in/out port is provided with an opening/closing shutter (not illustrated).

A spin chuck 480 that holds and rotates support wafer S is installed in the center portion within processing chamber 470. Spin chuck 480 has a horizontal upper surface, and the upper surface is provided with, for example, a suction port (not illustrated) that sucks support wafer S. Support wafer S may be adsorbed and held on spin chuck 480 via the suction from the suction port.

In the down side of spin chuck 480, a chuck driving unit 481 including, for example, a motor is installed. Spin chuck 480 may be rotated with a predetermined speed by chuck driving unit 481. Chuck driving unit 481 is provided with an elevation driving source such as, for example, a cylinder, and spin chuck 480 may be freely movable.

In the surrounding of spin chuck 480, a cup 482 which receives and recovers the liquid scattered or dropped from support wafer S, is installed. A discharge pipe 483 that discharges the recovered liquid and an exhaust pipe 484 that exhausts the atmosphere within cup 482 in a vacuum state, are connected to the bottom surface of cup 482.

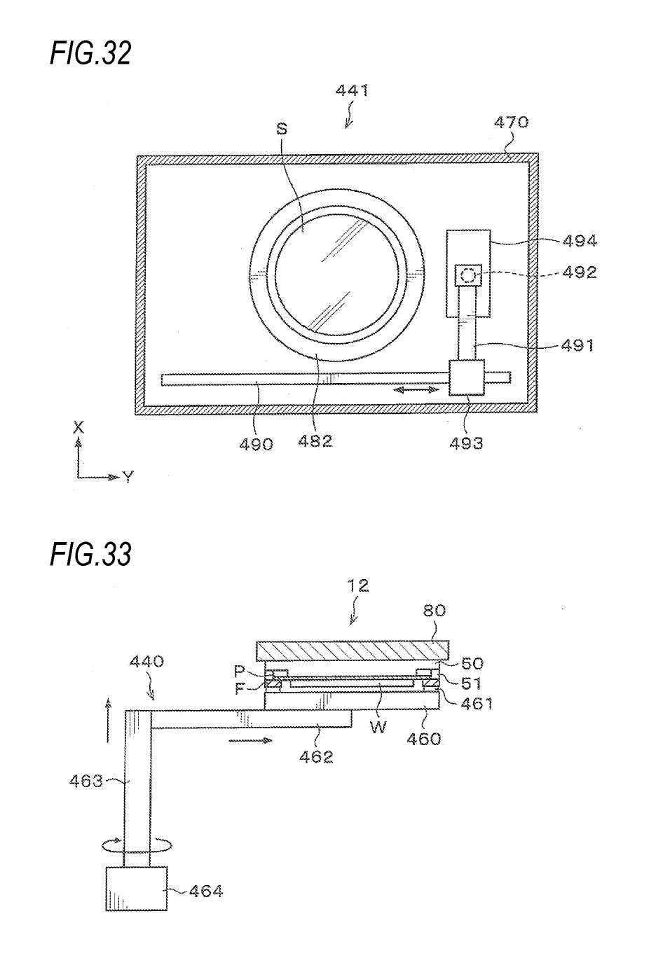

As illustrated in FIG. 32, in a minus side of cup 482 in the X-direction (down direction in FIG. 32), a rail 490 is formed which extends along the Y-direction (left and right direction in FIG. 32). Rail 490 is formed, for example, from the outside of the minus side of cup 482 in the Y-direction (left direction in FIG. 32) to the outside of the plus side of cup 482 in the Y-direction (right direction in FIG. 32). An arm 491 is attached to rail 490.

As illustrated in FIGS. 31 and 32, arm 491 supports a cleaning liquid nozzle 492 that supplies a cleaning liquid such as, for example, an organic solvent which is a solvent L of adhesive G to support wafer S. Arm 491 moves freely on rail 490 by a nozzle driving unit 493 as illustrated in FIG. 32. Therefore, cleaning liquid nozzle 492 may move from a stand-by portion 494 installed in the outside of cup 482 in the plus side of the Y-direction to a place above the center portion of support wafer S within cup 482, and moreover, may move above support wafer S in the diameter direction of support wafer S. Arm 491 may be freely movable by nozzle driving unit 493, and may adjust the height of cleaning liquid nozzle 492.

As for cleaning liquid nozzle 492, for example, a two-fluid nozzle is used. As illustrated in FIG. 31, a supply pipe 500 that supplies a cleaning liquid to cleaning liquid nozzle 492 as described above is connected to cleaning liquid nozzle 492. Supply pipe 500 is communicated with a cleaning liquid supply source 501 that stores a cleaning liquid therein. Supplying mechanism group 502 including a valve or a flow meter controller that controls the flow of a cleaning liquid is installed in supply pipe 500. Further, a supply pipe 503 that supplies an inert gas, for example, a nitride gas to cleaning liquid nozzle 492 as described above, is connected to cleaning liquid nozzle 492. Supply pipe 503 is communicated with an inert gas supply source 504 that stores an inert gas therein. Supplying mechanism group 505 including a valve or a flow meter controller that controls the flow of a gas is installed in supply pipe 503. And, the cleaning liquid and the inert gas are mixed within cleaning liquid nozzle 492 to be supplied to support wafer S from cleaning liquid nozzle 492. Meanwhile, hereinafter, a mixed one of the cleaning liquid and the inert gas may be simply referred to as “a cleaning liquid”.

In the down side of spin chuck 480, elevating pins (not illustrated) may be installed, which support and elevate support wafer S from below. Each of the elevating pins is configured such that the pin is inserted and penetrated through a through-hole (not illustrated) formed on spin chuck 480 to protrude from the upper surface of spin chuck 480. The elevating pins are elevated instead of the elevating of spin chuck 480, and thus support wafer S may be exchanged between spin chuck 480 and the elevating pins.

In second cleaning apparatus 441, a back rinse nozzle (not illustrated) that injects a cleaning liquid toward the rear surface of support wafer S, that is, a non-joint surface S_{N}, may be installed in the down side of spin chuck 480. Non-joint surface S_{N} of support wafer S and the outer peripheral of support wafer S are cleaned by the cleaning liquid injected from the back rinse nozzle.

Next, a separating method of target wafer W and support wafer S performed using separation system 400 as described above will be described.

First, cassette C_{T} received with a plurality of complex wafers T, empty cassette C_{W} and empty cassette C_{S} are disposed in a predetermined cassette disposing plate 421 of carrying-in/out station 410. Complex wafer T within cassette C_{T} is drawn out by first transporting arm 430 to be transported to separating apparatus 12 of processing station 411. At this time, complex wafer T is transported in a state where complex wafer T is held by dicing frame F and dicing tape P, target wafer W is disposed in the upper side, and support wafer S is disposed in the lower side.

Complex wafer T carried-in to separating apparatus 12 is separated into target wafer W and support wafer S. The separating method of target wafer W and support wafer S in separating apparatus 12 is the same as the method described in the exemplary embodiments as described above, and thus, the description thereof will be omitted.

Then, target wafer W separated in separating apparatus 12 is transported to first cleaning apparatus 13 by second transporting device 440. Herein, the transporting method of target wafer W by second transporting device 440 will be described. Target wafer W is held by dicing frame F and dicing tape P.

As illustrated in FIG. 33, support arm 462 is stretched to dispose transporting arm 460 in a place below target wafer W held by first holding unit 50. Then, transporting arm 460 ascends to stop the suction of target wafer W from suction pipe 60 in first holding unit 50. Target wafer W is transferred to transporting arm 460 from first holding unit 50.

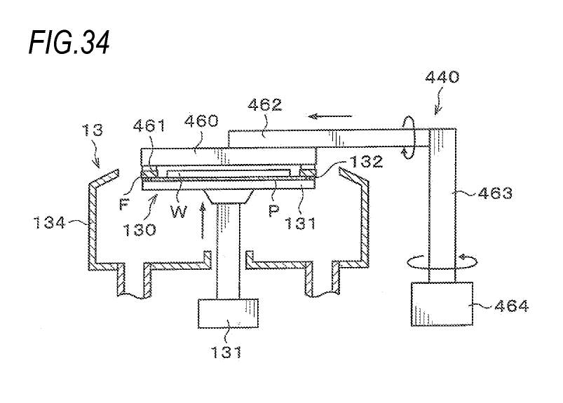

Next, as illustrated in FIG. 34, support arm 462 is rotationally moved to move transporting arm 460 to a place above wafer holding unit 130 of first cleaning apparatus 13, and transporting arm 460 is reversed so that target wafer W faces downward. At this time, wafer holding unit 130 moves to a position higher than cup 134 and is in a stand-by position. Then, target wafer W is transferred to wafer holding unit 130 from transporting arm 460 to be adsorbed and held by wafer holding unit 130.

When target wafer W is adsorbed and held by wafer holding unit 130 as described above, wafer holding unit 130 descends to a predetermined position. Next, joint surface W_{J} of target wafer W is cleaned by cleaning jig 140. The cleaning method of joint surface W_{J} of target wafer W in first cleaning apparatus 13 is the same as the method described in the exemplary embodiments as described above, and thus, the description thereof will be omitted.

The plurality of complex wafers T carried-in to carrying-in/out station 410 are inspected in advance to be distinguished between complex wafers T including normal target wafers W and complex wafers T including defect target wafers W, as described above.

Normal target wafer W separated from normal complex wafer T is transported to inspecting device 415 by third transporting device 451 after joint surface W_{J} of target wafer W is cleaned in first cleaning apparatus 13. The transporting of target wafer W by third transporting device 451 is almost the same as the transporting of target wafer W by second transporting device 440 as described above, and thus, the description thereof will be omitted.

In inspecting device 415, it is inspected whether the residue of adhesive G remains on joint surface W_{J} of target wafer W. When the residue of adhesive G is found in inspecting device 415, target wafer W is transported to joint surface cleaning unit 416a of post inspection cleaning apparatus 416 by third transporting device 451, and joint surface W_{J} is cleaned in joint surface cleaning unit 416a. When joint surface W_{J} is cleaned, target wafer W is transported to reversing unit 416c by third transporting device 451 to be reversed in up and down direction in reversing unit 416c. When the residue of adhesive G is not found, target wafer W is reversed in reversing unit 416c without being transported to joint surface cleaning unit 416a.

Then, the reversed wafer W is transported to inspecting device 415, again, and the inspection of non-joint surface W_{N} is performed. When the residue of adhesive G in non-joint surface W_{N} is found, target wafer W is transported to non-joint surface cleaning unit 416b by third transporting device 451, and non-joint surface W_{N} is cleaned. Next, the cleaned target wafer W is transported to post-processing station 412 by third transporting device 451. When the residue of adhesive G is not found in inspecting device 415, target wafer W is transported to post-processing station 412 without being transported to non-joint surface cleaning unit 416b.

Then, a predetermined post-processing for target wafer W is performed in post-processing station 412. As such, target wafer W becomes a product.

Meanwhile, target wafer W with a defect separated from complex wafer T with a defect is transported to cassette C_{W} of carrying-in/out station 410 by first transporting device 430 after joint surface W_{J} of target wafer W is cleaned in first cleaning apparatus 13. Then, target wafer W with a defect is carried-out from carrying-in/out station 410 to outside and recovered.

While the processing as described above is performed for target wafer W separated in separating apparatus 12, support wafer S separated in separating apparatus 12 is transported to second cleaning device 441 by first transporting device 430.

Support wafer S carried-in to second cleaning device 441 is adsorbed and held by spin chuck 480. Then, spin chuck 480 descends to a predetermined position. Next, cleaning liquid nozzle 492 in stand-by portion 494 is moved to a place above the center portion of support wafer S using arm 491. Then, a cleaning liquid is supplied to joint surface S_{J} of support wafer S from cleaning liquid nozzle 492 while support wafer S is rotated by spin chuck 480. The supplied cleaning liquid is diffused to the entire surface of joint surface S_{J} of support wafer S by the centrifugal force to clean joint surface S_{J} of support wafer S.

Then, support wafer S cleaned in second cleaning apparatus 441 is transported to cassette C_{S} of carrying-in/out station 410 by first transporting device 430. Then, support wafer S is carried-out from carrying-in/out station 410 to outside to be recovered. In this way, a series of separating of target wafer W and support wafer S in separation system 400 is completed.

According to separation system 400 in the exemplary embodiment as described above, after complex wafer T is separated into target wafer W and support wafer S in separating apparatus 12, the separated target wafer W may be cleaned in first cleaning apparatus 13 and the separated support wafer S may be cleaned in second cleaning apparatus 441. According to the present exemplary embodiment, within a single separation system 400, a series of separation processes including a separation of target wafer W and support wafer S and a cleaning of target wafer W and support wafer S, may be effectively performed. In first cleaning apparatus 13 and second cleaning apparatus 441, the cleaning of target wafer W and the cleaning of support wafer S may be performed in parallel, respectively. Moreover, while target wafer W and support wafer S are separated from each other in separating apparatus 12, other target wafer W and other support wafer S may be processed in first cleaning apparatus 13 and second cleaning apparatus 441. Therefore, the separation of target wafer W and support wafer S may be effectively performed to improve throughput of the separating.

In such a series of processes, from the separation of target wafer W and support wafer S to the post-processing of target wafer W may be performed, and thus the throughput of the wafer processing may be further improved.

In the exemplary embodiments as described above, a case where target wafer W is subject to a post-processing in post-processing station 412 to make a product is described, but the present disclosure may also be applied to a case where a target wafer used in, for example, three-dimensional integration technology is separated from a support wafer. The three-dimensional integration technology meets with a recent demand of the high-integration of semiconductor devices, and is a technology in which a plurality of semiconductor devices are three-dimensionally stacked instead of disposing the plurality of semiconductor devices in a horizontal surface. In the three-dimensional integration technology, a target wafer to be stacked needs to be thin, and thus, a predetermined processing is performed to the target wafer while being bonded to a support wafer.

From the foregoing, although preferred embodiments of the present invention are described by referring to accompanying drawings, the present invention is not limited thereto. It will be appreciated that those skilled in the art can derivate various modifications and revisions within the scope and spirit claimed in following clams, and also these modifications and revisions fall within the scope of the present invention.

The present invention is not limited to the exemplary embodiments as described above, but may adopt various aspects. The present invention may be applied to a case where a substrate is a flat panel display (FPD) or a mask reticle for a photo-mask other than a wafer.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

What is claimed is:

1. A cleaning apparatus comprising:
a rotation holding unit configured to hold and rotate a target substrate in a state in which, after the target substrate is separated from a complex substrate where the target substrate and a support substrate are bonded using an adhesive, the separated target substrate is disposed in an inner side of an annular frame and held by a tape adhered on the surface of the annular frame and a non-joint surface of the target substrate; and
a cleaning jig including a supplying surface configured to cover a joint surface of the target substrate, the cleaning jig further including:
a cleaning liquid supplying unit configured to supply a cleaning liquid between the joint surface and the supplying surface, thereby cleaning the joint surface of the target substrate, and
a cleaning liquid suction unit configured to suck the cleaning liquid supplied between the joint surface and the supplying surface.

2. The cleaning apparatus of claim 1, wherein a plurality of recess portions are formed in the supplying surface of the cleaning jig in a concentric circle form with the supplying surface of the cleaning jig.

3. The cleaning apparatus of claim 1, wherein the cleaning liquid suction unit is formed in an annular shape along the outer peripheral of the supplying surface in the outer peripheral of the supplying surface.

4. The cleaning apparatus of claim 1, wherein the cleaning jig is provided with a gas supplying unit configured to supply a gas to a step portion formed above the tape between the target substrate and the frame.

5. The cleaning apparatus of claim 3, further comprising a control unit configured to control the rotation holding unit such that the target substrate is rotated with 50 rpm.

6. The cleaning apparatus of claim 1, wherein the cleaning liquid suction unit is provided in the outer side of the step portion formed above the tape between the target substrate and the frame.

7. The cleaning apparatus of claim 6, further comprising a control unit configured to control the rotation holding unit such that the target substrate is rotated with 1000 rpm to 2000 rpm.

8. The cleaning apparatus of claim 1, wherein the cleaning jig is provided with a cover configured to be freely movable forwardly and backwardly with respect to a step portion formed above the tape between the target substrate and the frame, and cover the tape in the step portion.

9. The cleaning apparatus of claim 1, wherein the frame is provided with a protrusion that protrudes in a step portion formed above the tape between the target substrate and the frame.

10. A separation system comprising:
a processing station including a separating apparatus configured to separate a complex substrate into a target substrate and a support substrate, a cleaning apparatus configured to clean the target substrate separated by the separating apparatus, and a cleaning apparatus configured to clean the support substrate separated by the separating apparatus;
a carrying-in/out station configured to carry in/out the target substrate, the support substrate or the complex substrate with respect to the processing station; and
a transporting device configured to transport the target substrate, the support substrate or the complex substrate between the processing station and the carrying-in/out station,
wherein the separation system includes the cleaning apparatus including:
a rotation holding unit configured to hold and rotate a target substrate in a state in which, after the target substrate is separated from a complex substrate where the target substrate and a support substrate are bonded using an adhesive, the separated target substrate is disposed in an inner side of an annular frame and held by a tape adhered on the surface of the annular frame and a non-joint surface of the target substrate; and
a cleaning jig including a supplying surface configured to cover a joint surface of the target substrate, the cleaning jig further including:
a cleaning liquid supplying unit configured to supply a cleaning liquid between the joint surface and the supplying surface, thereby cleaning the joint surface of the target substrate, and
a cleaning liquid suction unit configured to suck the cleaning liquid supplied between the joint surface and the supplying surface.

11. A cleaning method comprising:
disposing a cleaning jig to face a target substrate such that a supplying surface of a cleaning jig, which is configured to supply a solvent of adhesive on a joint surface of the target substrate, covers the joint surface in a state in which, after the target substrate is separated from a complex substrate where the target substrate and a support substrate are bonded using the adhesive, the separated target substrate is disposed in an inner side of an annular frame and held by a tape adhered on the surface of the annular frame and a non-joint surface of the target substrate;
supplying a cleaning liquid between the supplying surface of the cleaning jig and the joint surface of the target substrate to diffuse the supplied cleaning liquid on the joint surface while rotating the target substrate, thereby cleaning the joint surface of the target substrate; and
sucking the cleaning liquid diffused on the joint surface of the target substrate.

12. The cleaning method of claim 11, wherein a plurality of recess portions are formed in the supplying surface of the cleaning jig in a concentric circle shape with the supplying surface of the cleaning jig, and
the cleaning liquid is diffused on the joint surface of the target substrate for each of the recess portions in the cleaning.

13. The cleaning method of claim 11, wherein the cleaning liquid is sucked from the outer peripheral of the cleaning jig in the sucking.

14. The cleaning method of claim 11, wherein a gas is supplied to a step portion formed above the tape between the target substrate and the frame in the cleaning.

15. The cleaning method of claim 13, wherein the target substrate is rotated with 50 rpm in the cleaning, and
the sucking is performed in a state where the rotation of the target substrate is stopped.

16. The cleaning method of claim 11, wherein the cleaning liquid is sucked from the outer side of a step portion formed above the tape between the target substrate and the frame in the sucking.

17. The cleaning method of claim 16, wherein the target substrate is rotated with 1000 rpm to 2000 rpm in the cleaning.

18. The cleaning method of claim 11, wherein the cleaning and the sucking are performed in a state where a cover that covers the tape in a step portion is formed in the step portion formed above the tape between the target substrate and the frame.

19. The cleaning method of claim 11, wherein the frame is provided with a protrusion that protrudes in a step portion formed above the tape between the target substrate and the frame.
